(19) United States
(12) Patent Application Publication
(10) Pub. No.: US 2015/0063171 A1
(43) Pub. Date: Mar. 5, 2015

(54) METHOD AND APPARATUS FOR TRANSMITTING MULTIMEDIA DATA DURING CALL ORIGINATION IN COMMUNICATION TERMINAL

(71) Applicant: Samsung Electronics Co., Ltd., Suwon-si (KR)

(72) Inventor: Moongyo BAE, Suwon-si (KR)

(21) Appl. No.: 14/466,299

(22) Filed: Aug. 22, 2014

(30) Foreign Application Priority Data
Sep. 4, 2013 (KR) 10-2013-0106062

(51) Int. Cl. H04W 4/16; H04M 3/42

(52) U.S. Cl. CPC H04W 4/16; H04M 3/42042
USPC 370/259

(57) ABSTRACT

A method and an apparatus for transmitting multimedia data during call origination in a communication terminal are provided. The method includes determining whether origination of a call is requested together with alerting media, when the origination of the call is requested, and transmitting a call origination message and data of the alerting media when the origination of the call is requested together with the alerting media.

### CROSS-REFERENCE TO RELATED APPLICATION(S)

This application claims the benefit under 35 U.S.C. §119(a) of a Korean patent application filed on Sep. 4, 2013 in the Korean Intellectual Property Office and assigned Serial number 10-2013-0106062, the entire disclosure of which is hereby incorporated by reference.

### TECHNICAL FIELD

The present disclosure relates to a method and an apparatus for transmitting multimedia data in a mobile communication terminal. More particularly, the present disclosure relates to a method and an apparatus for transmitting multimedia data during call origination in a mobile communication terminal

### BACKGROUND

Typically, methods for performing a voice telephony call in a communication system may be largely divided into a Circuit Switched (CS) method and a method using a packet scheme. Recently, with the rapid progress of a mobile communication technology, services which support a voice telephony call based on a packet are rapidly increasing. In a mobile communication system, a representative example of a packet-based voice service is a Long Term Evolution (LTE) voice communication (Voice over LTE (VoLTE)) service.

Meanwhile, a situation is considered in which a particular user makes a telephone call to another user. When a caller makes a telephone call to a callee, typically, until the callee receives the telephone call, the caller hears a ring back tone, or hears a ringtone or a guide announcement previously set by the callee.

On the other hand, when the caller is a pre-registered user, the callee can identify the registered information (e.g., a photograph, a name, etc.). Also, when the caller transmits the registered information together with characters such as lettering, the callee may receive and identify characters, that the caller has previously set, through a communication network.

However, the caller does not have a method, in which the caller can deliver a current emotion, location, situation, or the like of the caller to the callee before talking on the telephone. Specifically, the callee may recognize only a situation of the termination of a call through a ringtone previously set by the callee. Alternatively, the callee may identify only a photograph of the caller that the callee has previously registered, or may identify only a message that the caller has previously registered in a communication system. In other words, the caller does not have a method, in which the caller can deliver the emotion of the caller to the callee during a time period of telephone call connection standby (i.e., alerting) before a telephone call begins.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus capable of delivering the emotion of a caller during an alerting time period before a telephone call begins in an electronic device that provides voice communication.

Another aspect of the present disclosure is to provide a method and an apparatus capable of delivering multimedia data during an alerting time period in an electronic device that provides voice communication based on a packet.

Another aspect of the present disclosure is to provide a method and an apparatus capable of delivering the intention of a telephone call to a callee during an alerting time period.

Another aspect of the present disclosure is to provide a method and an apparatus capable of receiving multimedia data during an alerting time period from a particular caller.

In accordance with an aspect of the present disclosure, a method for transmitting multimedia data during call origination in a communication terminal is provided. The method includes determining whether origination of a call is requested together with alerting media, when the origination of the call is requested, and transmitting a call origination message and data of the alerting media when the origination of the call is requested together with the alerting media.

In accordance with another aspect of the present disclosure, an apparatus for transmitting multimedia data during call origination in a communication terminal is provided. The apparatus includes a communication module configured to communicate with a counterpart terminal, a display module configured to display produced alerting media and to display an operation of terminating a call, an operation of originating a call, a state of terminating the call, and a state of originating the call, a memory configured to store data of the alerting media and an address of the counterpart terminal, a user input module configured to generate an input signal matched to an input from a user, a camera module configured to receive at least one of a still image, a moving image, and a sound signal, and a controller configured to control the communication module to transmit the alerting media and a call origination message when the origination of the call is requested together with the alerting media.

When use is made of the method according to an embodiment of the present disclosure, a caller can directly produce multimedia content and can transmit the multimedia content to a callee during an alerting time period. Through the transmission of the multimedia content, the caller can not only deliver the intention of making a telephone call, but can also deliver the emotion of the caller. Also, through the transmission of the multimedia content, even before the telephone call begins, the caller can deliver a brief opinion or the intention of the caller to the callee.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a block diagram illustrating a configuration of hardware according to an embodiment of the present disclosure;

FIG. 3 is a block diagram illustrating a configuration of a programming module according to an embodiment of the present disclosure;

FIG. 4 is a view illustrating an example of a case in which a transmission-side electronic device communicates with a reception-side electronic device through a predetermined network according to an embodiment of the present disclosure;

FIG. 5 is a flowchart illustrating a flow of control in a case where a transmission-side electronic device produces alerting media and originates a call according to an embodiment of the present disclosure;

FIG. 6A is a view illustrating an example of a user interface of a transmission-side electronic device which inquires about a method for producing alerting media according to an embodiment of the present disclosure;

FIG. 6B is a view illustrating an example of a user interface in a case where a transmission-side electronic device produces alerting media in the form of a moving image according to an embodiment of the present disclosure;

FIG. 6C and FIG. 6D are views respectively illustrating an example of a user interface inquiring about origination and that of a case of performing the origination, after alerting media are produced according to an embodiment of the present disclosure;

FIG. 7 is a flowchart illustrating the flow of control over the transmission of media during an alerting time period when a transmission-side electronic device originates a call according to an embodiment of the present disclosure;

FIG. 8 is a flowchart illustrating the flow of control in a case where a reception-side electronic device sets target media to be transmitted during an alerting time period when receiving an incoming call according to an embodiment of the present disclosure;

FIG. 9A is a view illustrating an example of a form displayed when an electronic device receiving an incoming call sets the reception of media to be transmitted during telephone call connection standby according to an embodiment of the present disclosure; and

FIG. 9B is a view illustrating an example of a case in which a reception-side electronic device allows a termination call of media when waiting for a telephone call connection from a particular user according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component there between. The terms used in the present disclosure are only used to describe specific various embodiments, and are not intended to limit the present disclosure. As used herein, the singular forms are intended to include the plural forms as well, unless the context clearly indicates otherwise. Singular forms are intended to include plural forms unless the context clearly indicates otherwise.

An electronic device according to the present disclosure may be a device including a communication function. For example, the device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a TeleVision (TV), a Digital Video Disk (DVD) player, an audio device, various medical devices (for example, Magnetic Resonance Angiography (MRA), Magnetic Resonance Imaging (MRI), Computed Tomography (CT), a scanning machine, a ultrasonic wave device, or the like), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device according to the present disclosure is not limited to the aforementioned devices.

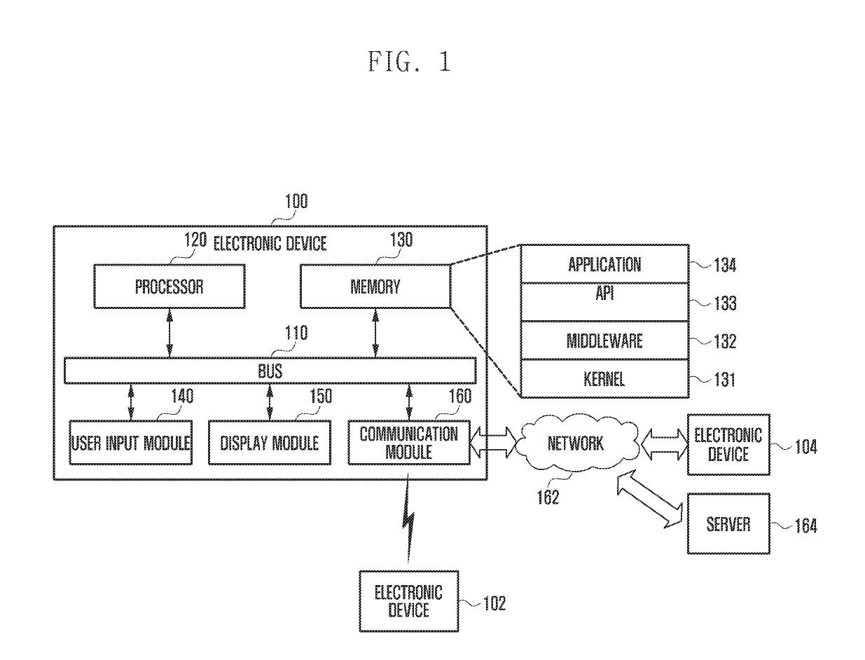

FIG. 1 is a block diagram illustrating a configuration of an electronic device according to an embodiment of the present disclosure.

Referring to FIG. 1, the electronic device 100 may include a bus 110, a processor 120, a memory 130, a user input module 140, a display module 150, a communication module 160, and other similar and/or suitable components.

The bus 110 may be a circuit which interconnects the above-described elements and delivers a communication (e.g., a control message) between the above-described elements.

The processor 120 may receive commands from the above-described other elements (e.g., the memory 130, the user input module 140, the display module 150, the communication module 160, etc.) through the bus 110, may interpret the received commands, and may execute calculation or data processing according to the interpreted commands.

The memory 130 may store commands or data received from the processor 120 or other elements (e.g., the user input module 140, the display module 150, the communication module 160, etc.) or generated by the processor 120 or the other elements. The memory 130 may include programming modules, such as a kernel 131, middleware 132, an Application Programming Interface (API) 133, an application 134, and the like. Each of the above-described programming modules may be implemented in software, firmware, hardware, or a combination of two or more thereof.

The kernel 131 may control or manage system resources (e.g., the bus 110, the processor 120, the memory 130, etc.) used to execute operations or functions implemented by other programming modules (e.g., the middleware 132, the API 133, and the application 134). Also, the kernel 131 may provide an interface capable of accessing and controlling or managing the individual elements of the electronic device 100 by using the middleware 132, the API 133, or the application 134.

The middleware 132 may serve to go between the API 133 or the application 134 and the kernel 131 in such a manner that the API 133 or the application 134 communicates with the kernel 131 and exchanges data therewith. Also, in relation to work requests received from one or more applications 134 and/or the middleware 132, for example, may perform load balancing of the work requests by using a method of assigning a priority, in which system resources (e.g., the bus 110, the processor 120, the memory 130, etc.) of the electronic device 100 can be used, to at least one of the one or more applications 134.

The API 133 is an interface through which the application 134 is capable of controlling a function provided by the kernel 131 or the middleware 132, and may include, for example, at least one interface or function for file control, window control, image processing, character control, or the like.

The user input module 140, for example, may receive a command or data as input from a user, and may deliver the received command or data to the processor 120 or the memory 130 through the bus 110. The display module 150 may display a video, an image, data, or the like to the user.

The communication module 160 may connect communication between another electronic device 102 and the electronic device 100. The communication module 160 may support a predetermined short-range communication protocol (e.g., Wi-Fi, BlueTooth (BT), and Near Field Communication (NFC)), or predetermined network communication 162 (e.g., the Internet, a Local Area Network (LAN), a Wide Area Network (WAN), a telecommunication network, a cellular network, a satellite network, a Plain Old Telephone Service (POTS), or the like). Each of the electronic devices 102 and 104 may be a device which is identical (e.g., of an identical type) to or different (e.g., of a different type) from the electronic device 100. Further, the communication module 160 may connect communication between a server 164 and the electronic device 100 via the network 162.

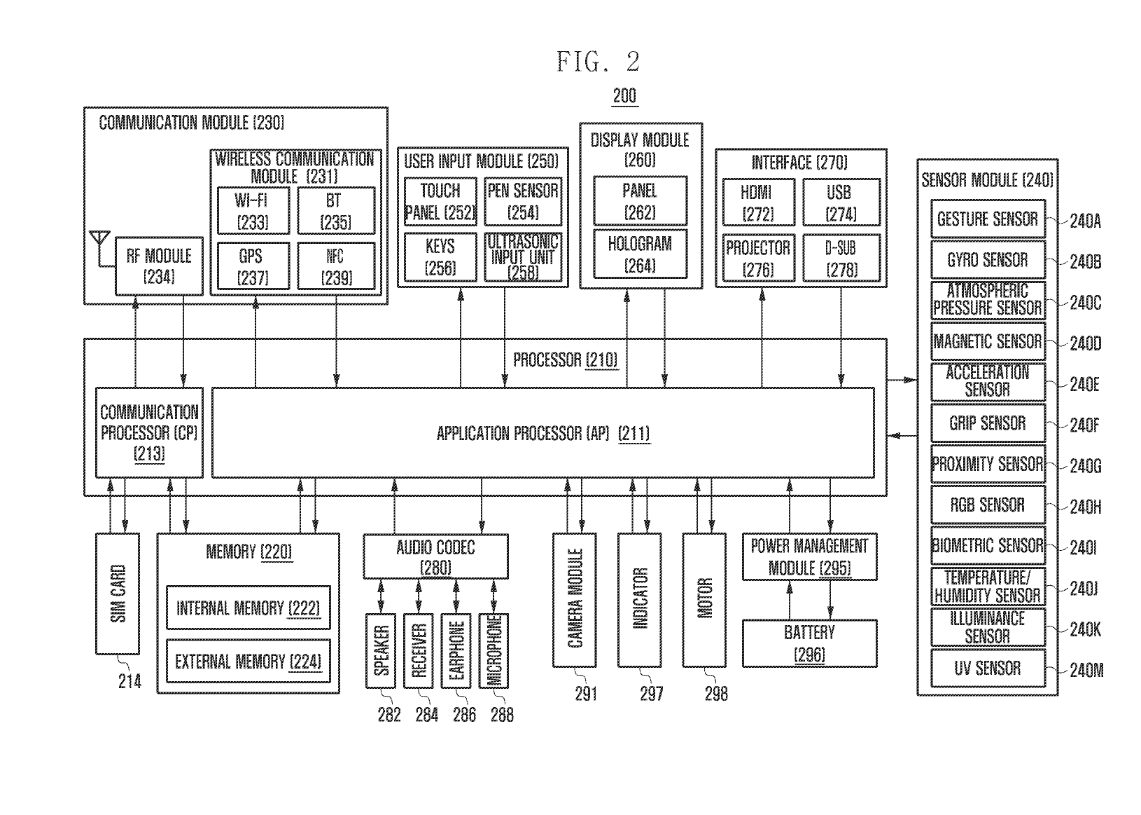

FIG. 2 is a block diagram illustrating a configuration of hardware 200 according to an embodiment of the present disclosure.

The hardware 200 may be, for example, the electronic device 100 illustrated in FIG. 1.

Referring to FIG. 2, the hardware 200 may include one or more processors 210, a Subscriber Identification Module (SIM) card 214, a memory 220, a communication module 230, a sensor module 240, a user input module 250, a display module 260, an interface 270, an audio coder/decoder (codec) 280, a camera module 291, a power management module 295, a battery 296, an indicator 297, a motor 298 and any other similar and/or suitable components.

The processor 210 (e.g., the processor 120) may include one or more Application Processors (APs) 211, or one or more Communication Processors (CPs) 213. The processor 210 may be, for example, the processor 120 illustrated in FIG. 1. The AP 211 and the CP 213 are illustrated as being included in the processor 210 in FIG. 2, but may be included in different Integrated Circuit (IC) packages, respectively. According to an embodiment of the present disclosure, the AP 211 and the CP 213 may be included in one IC package.

The AP 211 may execute an Operating System (OS) or an application program, and thereby may control multiple hardware or software elements connected to the AP 211 and may perform processing of and arithmetic operations on various data including multimedia data. The AP 211 may be implemented by, for example, a System on Chip (SoC). According to an embodiment of the present disclosure, the processor 210 may further include a Graphical Processing Unit (GPU) (not illustrated).

The CP 213 may manage a data line and may convert a communication protocol in the case of communication between the electronic device (e.g., the electronic device 100) including the hardware 200 and different electronic devices connected to the electronic device through the network. The CP 213 may be implemented by, for example, a SoC. According to an embodiment of the present disclosure, the CP 213 may perform at least some of multimedia control functions. The CP 213, for example, may distinguish and authenticate a terminal in a communication network by using a subscriber identification module (e.g., the SIM card 214). Also, the CP 213 may provide the user with services, such as a voice telephony call, a video telephony call, a text message, packet data, and the like.

Further, the CP 213 may control the transmission and reception of data by the communication module 230. In FIG. 2, the elements such as the CP 213, the power management module 295, the memory 220, and the like are illustrated as elements separate from the AP 211. However, according to an embodiment of the present disclosure, the AP 211 may include at least some (e.g., the CP 213) of the above-described elements.

According to an embodiment of the present disclosure, the AP 211 or the CP 213 may load, to a volatile memory, a command or data received from at least one of a non-volatile memory and other elements connected to each of the AP 211 and the CP 213, and may process the loaded command or data. Also, the AP 211 or the CP 213 may store, in a non-volatile memory, data received from or generated by at least one of the other elements.

The SIM card 214 may be a card implementing a subscriber identification module, and may be inserted into a slot formed in a particular portion of the electronic device 100. The SIM card 214 may include unique identification information (e.g., Integrated Circuit Card IDentifier (ICCID)) or subscriber information (e.g., International Mobile Subscriber Identity (IMSI)).

The memory 220 may include an internal memory 222 and an external memory 224. The memory 220 may be, for example, the memory 130 illustrated in

FIG. 1. The internal memory 222 may include, for example, at least one of a volatile memory (e.g., a Dynamic RAM (DRAM), a Static RAM (SRAM), a Synchronous Dynamic RAM (SDRAM), etc.), and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, etc.). According to an embodiment of the present disclosure, the internal memory 222 may be in the form of a Solid State Drive (SSD). The external memory 224 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, or the like.

The communication module 230 may include a wireless communication module 231 or a Radio Frequency (RF) module 234. The communication module 230 may be, for example, the communication module 160 illustrated in FIG. 1. The wireless communication module 231 may include, for example, a Wi-Fi part 233, a BT part 235, a GPS part 237, or a NFC part 239. For example, the wireless communication module 231 may provide a wireless communication function by using a radio frequency. Additionally or alternatively, the wireless communication module 231 may include a network interface (e.g., a LAN card), a modulator/demodulator (modem), or the like for connecting the hardware 200 to a network (e.g., the Internet, a LAN, a WAN, a telecommunication network, a cellular network, a satellite network, a POTS, or the like).

The RF module 234 may be used for transmission and reception of data, for example, transmission and reception of RF signals or called electronic signals. Although not illustrated, the RF unit 234 may include, for example, a transceiver, a Power Amplifier Module (PAM), a frequency filter, a Low Noise Amplifier (LNA), or the like. Also, the RF module 234 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green and Blue (RGB) sensor 240H, a biometric sensor 2401, a temperature/humidity sensor 240J, an illuminance sensor 240K, and a Ultra Violet (UV) sensor 240M. The sensor module 240 may measure a physical quantity or may sense an operating state of the electronic device 100, and may convert the measured or sensed information to an electrical signal. Additionally/alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor, and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit for controlling one or more sensors included therein.

The user input module 250 may include a touch panel 252, a pen sensor 254 (e.g., a digital pen sensor), keys 256, and an ultrasonic input unit 258. The user input module 250 may be, for example, the user input module 140 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware 200 may receive a user input from an external device (e.g., a network, a computer, or a server), which is connected to the communication module 230, through the communication module 230.

The display module 260 may include a panel 262 or a hologram 264. The display module 260 may be, for example, the display module 150 illustrated in FIG. 1. The panel 262 may be, for example, a Liquid Crystal Display (LCD) and an Active Matrix Organic Light Emitting Diode (AM-OLED) display, and the like. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present disclosure, the display module 260 may further include a control circuit for controlling the panel 262 or the hologram 264.

The interface 270 may include, for example, a High-Definition Multimedia Interface (HDMI) 272, a Universal Serial Bus (USB) 274, a projector 276, and a D-subminiature (D-sub) 278. Additionally or alternatively, the interface 270 may include, for example, SD/Multi-Media Card (MMC) (not illustrated) or Infrared Data Association (IrDA) (not illustrated).

The audio codec 280 may bidirectionally convert between a voice and an electrical signal. The audio codec 280 may convert voice information, which is input to or output from the audio codec 280, through, for example, a speaker 282, a receiver 284, an earphone 286, the microphone 288 or the like.

The camera module 291 may capture an image and a moving image. According to an embodiment, the camera module 291 may include one or more image sensors (e.g., a front lens or a back lens), an Image Signal Processor (ISP) (not illustrated), and a flash LED (not illustrated).

The power management module 295 may manage power of the hardware 200. Although not illustrated, the power management module 295 may include, for example, a Power Management Integrated Circuit (PMIC), a charger Integrated Circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state and the like. The motor 298 may convert an electrical signal into a mechanical vibration. The processor 210 may control the sensor module 240.

Although not illustrated, the hardware 200 may include a processing unit (e.g., a GPU) for supporting a module TV. The processing unit for supporting a module TV may process media data according to standards such as, for example, Digital Multimedia Broadcasting (DMB), Digital Video Broadcasting (DVB), media flow, and the like. Each of the above-described elements of the hardware 200 according to an embodiment of the present disclosure may include one or more components, and the name of the relevant element may change depending on the type of electronic device. The hardware 200 according to an embodiment of the present disclosure may include at least one of the above-described elements. Some of the above-described elements may be omitted from the hardware 200, or the hardware 200 may further include additional elements. Also, some of the elements of the hardware 200 according to an embodiment of the present disclosure may be combined into one entity, which may perform functions identical to those of the relevant elements before the combination.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an Application-Specific Integrated Circuit (ASIC) chip, a Field-Programmable Gate Array (FPGA), and a programmable-logic device for performing certain operations which have been known or are to be developed in the future.

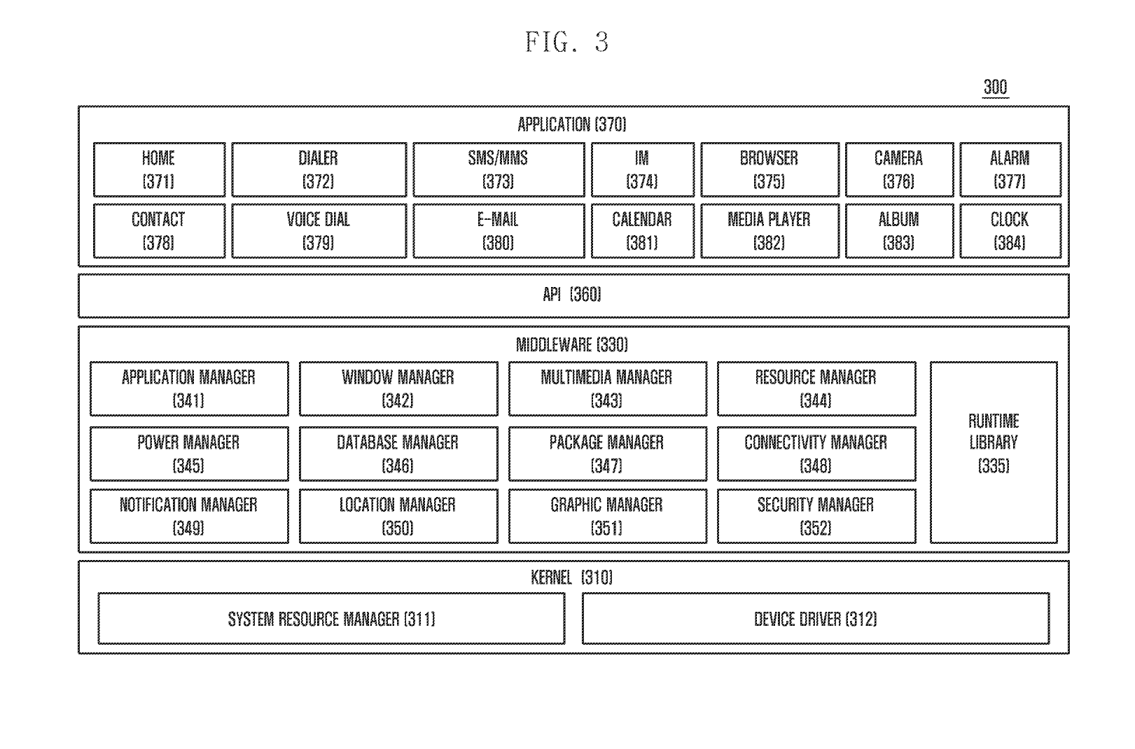

FIG. 3 is a block diagram illustrating a configuration of a programming module 300 according to an embodiment of the present disclosure.

The programming module 300 may be included (or stored) in the electronic device 100 (e.g., the memory 130) illustrated in FIG. 1. At least a part of the programming module 300 may be implemented in software, firmware, hardware, or a combination of two or more thereof. The programming module 300 may be implemented in hardware (e.g., the hardware 200), and may include an OS controlling resources related to an electronic device (e.g., the electronic device 100) and/or various applications (e.g., an application 370) executed in the OS. For example, the OS may be Android, iOS, Windows, Symbian, Tizen, Bada, and the like.

Referring to FIG. 3, the programming module 300 may include a kernel 310, a middleware 330, an API 360, and/or the application 370.

The kernel 310 (e.g., the kernel 131) may include a system resource manager 311 and/or a device driver 312. The system resource manager 311 may include, for example, a process manager 313, a memory manager 315, and a file system manager 317. The system resource manager 311 may perform the control, allocation, recovery, and/or the like of system resources. The device driver 312 may include, for example, a display driver 314, a camera driver 316, a Bluetooth driver 318, a shared memory driver 320, a USB driver 322, a keypad driver 324, a Wi-Fi driver 326, and/or an audio driver 328. Also, according to an embodiment of the present disclosure, the device driver 312 may include an Inter-Process Communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 134) may include, for example, a preloaded application and/or a third party application. The applications 370 (e.g., the applications 134) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Also, some of the operations may be omitted, or other operations may be added to the operations.

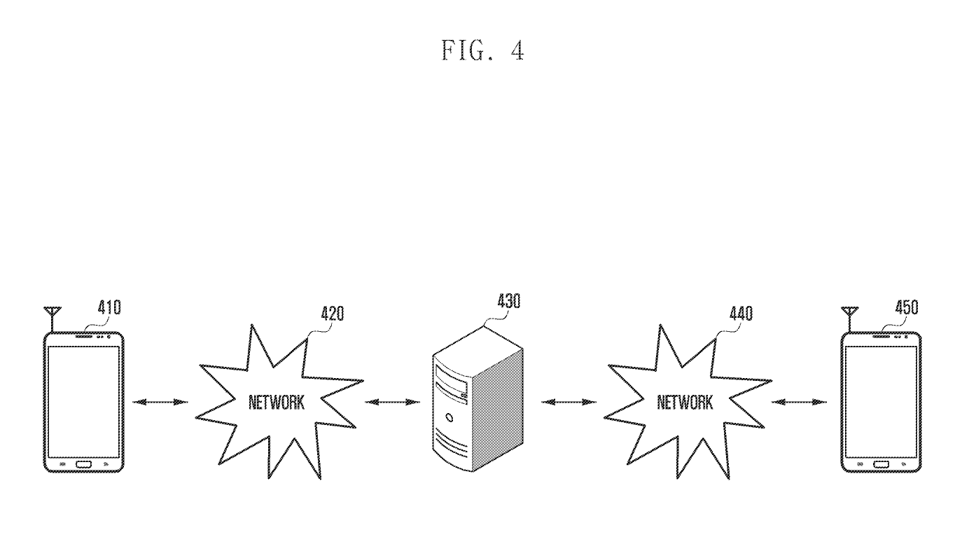

FIG. 4 is a view illustrating an example of a case in which a transmission-side electronic device communicates with a reception-side electronic device through a predetermined network according to an embodiment of the present disclosure.

Referring to FIG. 4, an electronic device 410 and an electronic device 450 may be the electronic devices illustrated in FIGS. 1 to 3. Hereinafter, for convenience of description, an embodiment of the present disclosure will be described with reference to the configuration of the electronic device illustrated in FIG. 1. Also, the electronic devices disclosed in the present specification are capable of performing a voice telephony call.

The electronic devices 410 and 450 may perform voice communication there between through networks 420 and 440, and are capable of performing a voice telephony call there between through a packet switching system 430. In the present example, the packet switching system 430 may be a system capable of providing a VoLTE service.

Consideration is given to a case in which the first electronic device 410 is a transmission-side electronic device and the second electronic device 450 is a reception-side electronic device. When a user of the first electronic device 410 generates and sends alerting media, the first electronic device 410 may transmit the alerting media to the packet switching system 430 through the network 420. Also, the packet switching system 430 may transmit the alerting media, together with or after an alert message notifying of call termination, to the reception-side second electronic device 450 through the network 440. Accordingly, the second electronic device 450 may notify of the call termination, and simultaneously, may receive the alerting media transmitted by the first electronic device 410 before reproducing the alerting media. Through the reception and reproduction of the alerting media, the alerting media may be provided to the user.

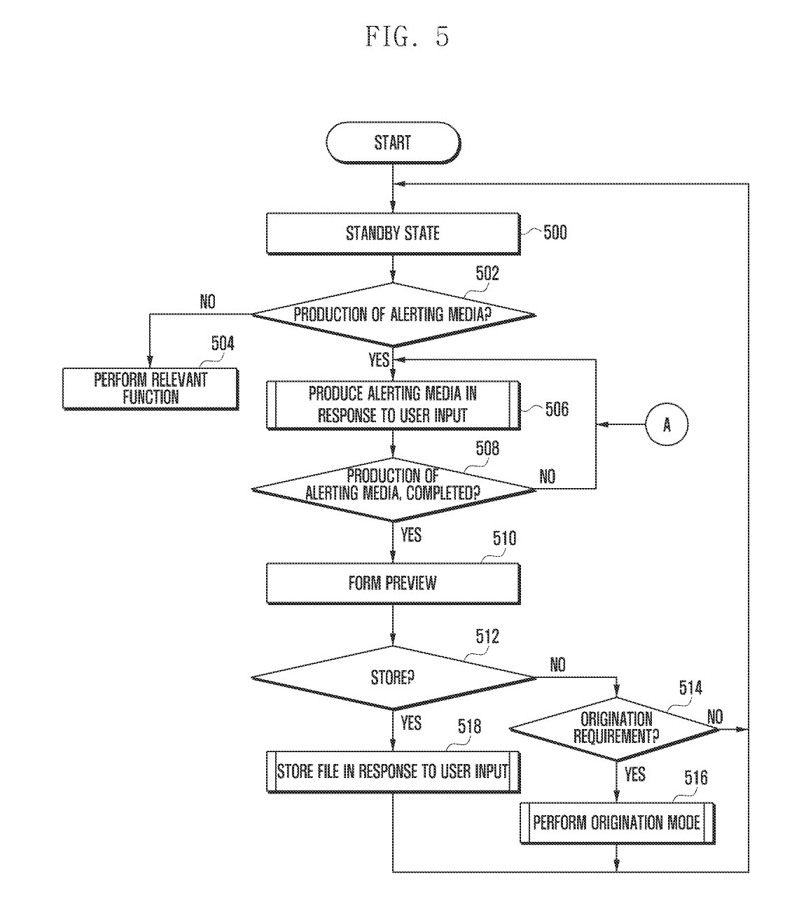

Hereinafter, the above-described transmission operation will be described with reference to FIG. 5.

FIG. 5 is a flowchart illustrating the flow of control in a case where a transmission-side electronic device produces alerting media and originates a call according to an embodiment of the present disclosure. Hereinafter, for convenience of description, operations of FIG. 5 will be described with reference to the configuration of the electronic device illustrated in FIG. 1. However, it will be apparent to those skilled in the art that an identical operation may be performed even when the configurations illustrated in FIGS. 2 and 3 are used.

In operation 500, the processor 120 maintains a standby state. Here, the standby state is a state of waiting for the occurrence of a particular event, and may signify a state of waiting for an event, such as the termination of a call, the arrival of an alarm time point, the reception of a message, the origination of a call requested by the user, the execution of a particular application requested by the user, or the like.

When the particular event occurs while the standby state is maintained, in operation 502, the processor 120 determines whether the production of alerting media is required. When a result of the determination in operation 502 shows that the production of alerting media is required, the processor 120 proceeds to operation 506. In contrast, when the result of the determination in operation 502 shows that the production of alerting media is not required, the processor 120 proceeds to operation 504, and performs a relevant function.

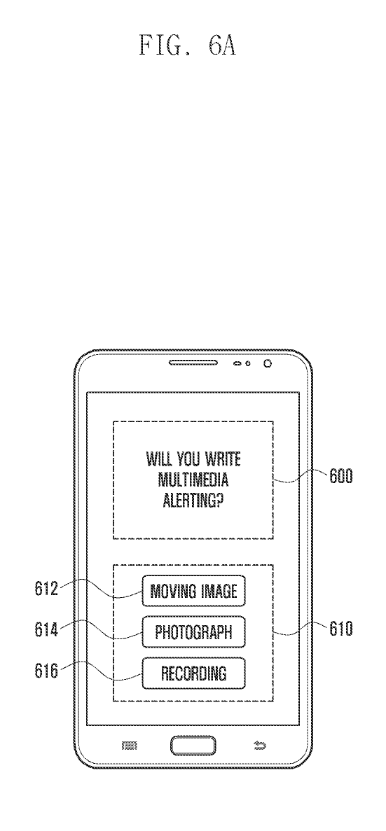

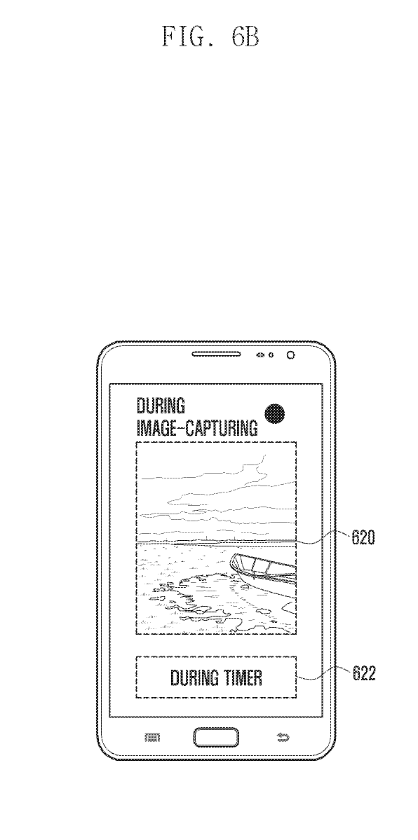

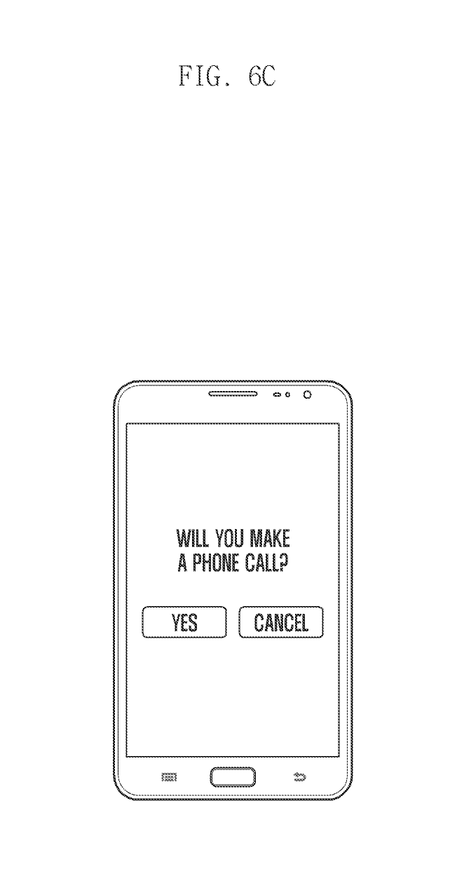

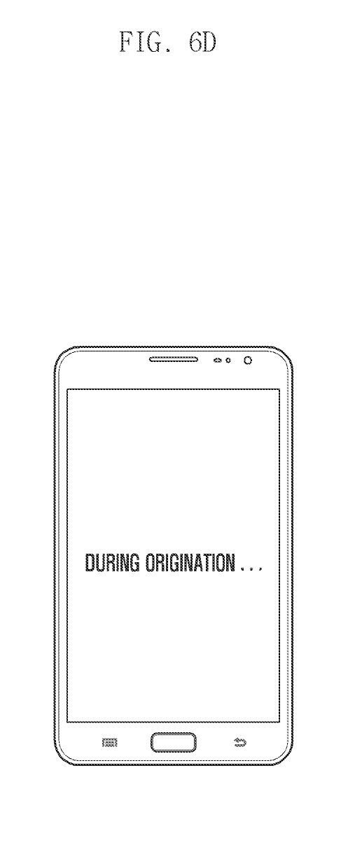

When proceeding to operation 506, the processor 120 produces alerting media in response to a user input signal which is input from the user input module 140. Such an operation of producing alerting media will be described with reference to FIG. 6A and FIG. 6B.

FIG. 6A is a view illustrating an example of a user interface of a transmission-side electronic device which inquires about a method for producing alerting media according to an embodiment of the present disclosure.

In operation 506, the processor 120 may control the display module 150, and may inquire of the user about a method for producing alerting media, which has a form illustrated in FIG. 6A. Specifically, the processor 120 inquires about the production of alerting media through a character display window 600 for displaying characters which inquire about the production of alerting media, and displays a scheme inquiry window 610 together which inquires about a scheme for producing alerting media. The scheme inquiry window 610 may include a moving image icon 612 for producing alerting media in a scheme for capturing a moving image; a photograph icon 614 for producing alerting media in a scheme for capturing a photograph; and a recording icon 616 for producing alerting media through recording of voice.

In addition to the schemes illustrated in FIG. 6A, the scheme inquiry window 610 may use a scheme for using characters, special symbols and the like, or may use a previously-produced flash file and the like, and may further include icons for respectively notifying of such schemes.

FIG. 6B is a view illustrating an example of a user interface in a case where a transmission-side electronic device produces alerting media in the form of a moving image according to an embodiment of the present disclosure.

Referring to FIG. 6B, the processor 120 may display an image, which has been captured through the camera module 291, on an image display window 620 of the display module 150. Also, the processor 120 may display an image-capturing time window 622 on a part of the display module 150. The alerting media are information capable of being provided before talking to the other party on the telephone after origination of a call, and thus are capable of being provided before a telephone call is performed between the transmission-side electronic device and the reception-side electronic device when a call is terminated. Accordingly, the alerting media may only be capable of being produced only until a time point when a call termination alarm rings during call termination, and thus the processor 120 may display a preset limited time period, and may display the preset limited time period after being down counted.

In operation 506, when the alerting media are produced, media of one type, such as a form of only a moving image, only a photograph, or the like, may be produced. However, two or more media, for example, a photograph and text, and a photograph after a moving image, may be produced together. The processor 120 may produce the alerting media by using only one medium or two or more media in response to a user input signal which is input from the user input module 140.

In operation 508, the processor 120 determines whether the production of the alerting media has been completed. The user may use the user input module 140 to instruct the production of the alerting media to be completed. Alternatively, the processor 120 may determine that the production of the alerting media has been completed, when a predetermined time period passes. Accordingly, in operation 508, the processor 120 may determine whether the production of the alerting media has been completed.

When a result of the determination in operation 508 shows that the production of the alerting media has been completed, the processor 120 may proceed to operation 510, and may control the display module 150 to form a preview. When the preview is formed in operation 510 as described above, the user may previously identify the produced alerting media. Also, the method illustrated in FIG. 5 may be implemented not to include operation 510, according to circumstances.

When the preview is stopped or completed, in operation 512, the processor 120 may generate a message inquiring about whether the produced alerting media are to be stored, and may display the generated message on the display module 150. When a result of the determination in operation 512 shows that it is to store the produced alerting media, the processor 120 proceeds to operation 518. In contrast, when the result of the determination in operation 512 shows that it is not to store the produced alerting media, the processor 120 proceeds to operation 514.

In operation 518, the processor 120 may store the produced alerting media in the memory 130 in response to a user input received from the user input module 140. Herein, the reason for storing data of the produced alerting media in response to the user input is for designating a file name, a storage location and the like of the produced alerting media. However, when the data of the produced alerting media is automatically stored, the processor 120 may not receive an input signal for storing the produced file, from the user input module 140.

Also, in FIG. 5, the method is configured to store the produced file in response to the user input and then proceed to the standby state in operation 500. Alternatively, the processor 120 may store the produced file in the memory 130, and may then proceed to operation 514.

Meanwhile, when proceeding from operation 512 to operation 514, the processor 120 may determine whether an origination request signal is received from the user input module 140. When a result of the determination in operation 514 shows that origination is requested, the processor 120 proceeds to operation 516, and performs an origination mode. In contrast, when the result of the determination in operation 514 shows that the origination is not requested, the processor 120 may proceed to operation 500.

When the origination is performed in operation 516, the processor 120 may transmit a produced alerting message, together with or after a call origination request message, to the reception-side electronic device. When the produced alerting message is transmitted to the reception-side electronic device as described above, if 1:1 communication is performed, direct transmission may be performed. Alternatively, the transmission may be performed through a particular network, as illustrated in FIG. 4.

Hereinafter, a form displayed by the transmission-side electronic device when origination requirement and origination are performed will be described with reference to FIG. 6C and FIG. 6D.

FIG. 6C and FIG. 6D are views respectively illustrating an example of a user interface inquiring about origination and that of a case of performing the origination, after alerting media are produced according to an embodiment of the present disclosure.

Referring to FIG. 6C, the electronic device may be configured to inquire of the user about whether origination is to be performed by displaying characters, a picture or the like, which enables the recognition of whether origination is to be performed, on the display module 150. Also, the electronic device may be configured to allow the user to select whether the origination is to be performed. Further, as illustrated in FIG. 6C, the electronic device may be configured to display only an origination state on the display module 150 when the origination is performed. Alternatively, the electronic device may be configured to display the produced alerting media on the display module 150 because the produced alerting media are transmitted when the origination is performed.

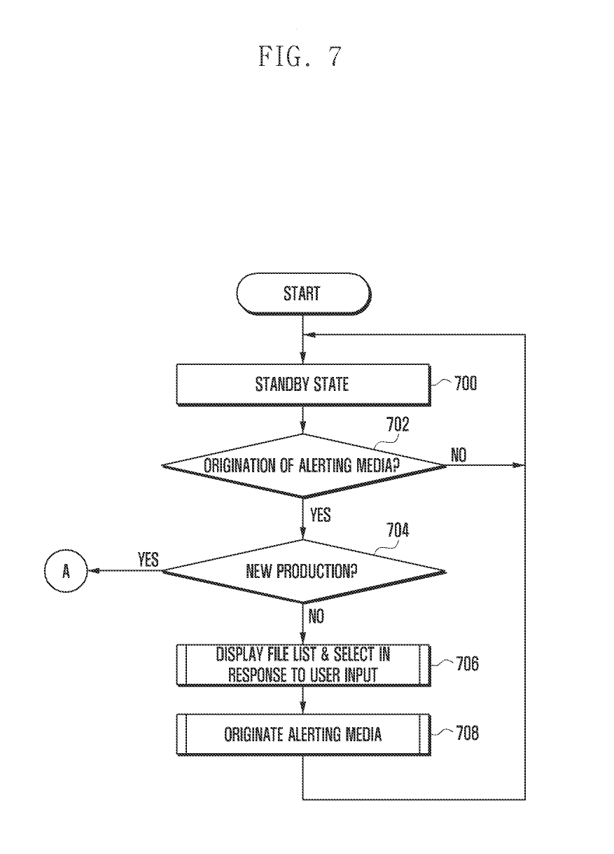

FIG. 7 is a flowchart illustrating the flow of control over the transmission of media during an alerting time period when a transmission-side electronic device originates a call according to an embodiment of the present disclosure.

In operation 700, the processor 120 may maintain a standby state. Here, the standby state is a state of waiting for the occurrence of a particular event, and may signify a state of waiting for an event, such as the termination of a call, the arrival of an alarm time point, the reception of a message, the origination of a call requested by the user, the execution of a particular application requested by the user, or the like.

When the particular event occurs in operation 700, the processor 120 proceeds to operation 702, and determines whether the origination of alerting media has been requested. In FIG. 7, only a case of origination of alerting media will be described for convenience in description, and thus other cases will not be described.

When a result of the determination in operation 702 shows that the origination of alerting media has not been requested, the processor 120 proceeds to operation 700. In contrast, when the origination of alerting media has been requested, the processor 120 proceeds to operation 704, and determines whether the new production of alerting media is requested. When a result of the determination in operation 704 shows that the new production of alerting media is requested, the processor may proceed to operation 506 illustrated in FIG. 5.

Meanwhile, a case in which the new production of alerting media is not requested may be a case in which origination is performed by using the previously-produced alerting media. Accordingly, when proceeding to operation 706, the processor 120 may display a file list on the display module 150 by using a signal which is input from the user input module 140, and may select one alerting media file included in the file list displayed in response to the user input.

As described above, when multiple alerting media are stored, an operation of selecting alerting media may select the alerting media in such a manner as to move a display area of a file according to a user input. This configuration may use a method for displaying data included in a particular folder in computers, smart phones, and the like.

When the selection of a particular alerting media file has been completed in operation 706, in operation 708, the processor 120 performs the origination of the alerting media. An operation of performing the origination of alerting media by the processor 120 is to control the communication module 160 to send a request for a telephone call to a particular user, and simultaneously or subsequently, to transmit data of the produced alerting media.

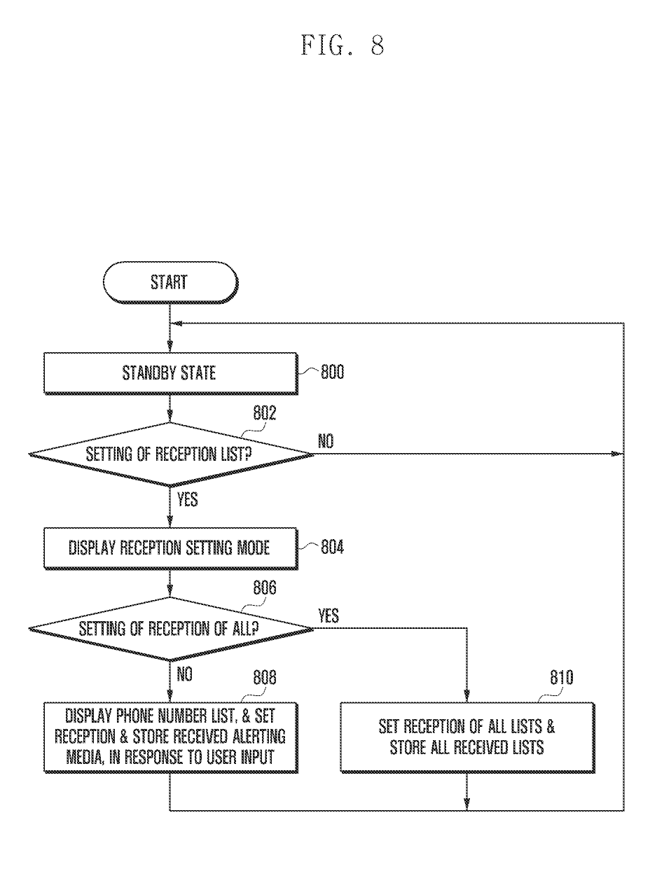

FIG. 8 is a flowchart illustrating the flow of control in a case where a reception-side electronic device sets target media to be transmitted during an alerting time period when receiving an incoming call according to an embodiment of the present disclosure. For convenience of description, the control flowchart illustrated in FIG. 8 will also be described with reference to, for example, the configuration of the electronic device illustrated in FIG. 1. However, it will be apparent to those skilled in the art that an identical operation may be performed even when the electronic device has the configuration illustrated in FIG. 2 or FIG. 3.

In operation 800, the processor 120 maintains a standby state. Here, the standby state is a state of waiting for the occurrence of a particular event, and may signify a state of waiting for an event, such as the termination of a call, the arrival of an alarm time point, the reception of a message, the origination of a call requested by the user, the execution of a particular application requested by the user, the setting of whether a termination call of alerting media is to be granted, or the like.

When the particular event occurs in operation 800, the processor 120 proceeds to operation 802, and determines whether a setting has been required for a list of the grant of a termination call of alerting media. When a result of the determination in operation 802 shows that the termination call of alerting media is granted, the processor 120 proceeds to operation 804. In contrast, when the termination call of alerting media is not granted, the processor 120 may perform a relevant function, and may proceed to operation 800. In this regard, in FIG. 8, only a case of a termination call of alerting media is described for convenience in description, and thus an operation of performing the relevant function is not illustrated.

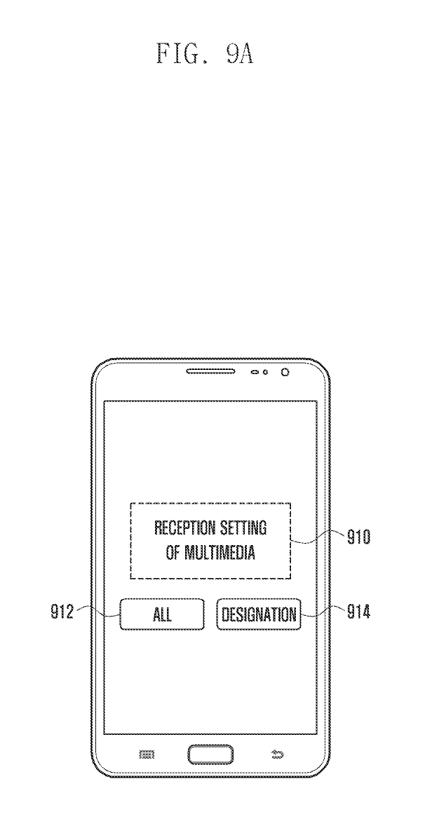

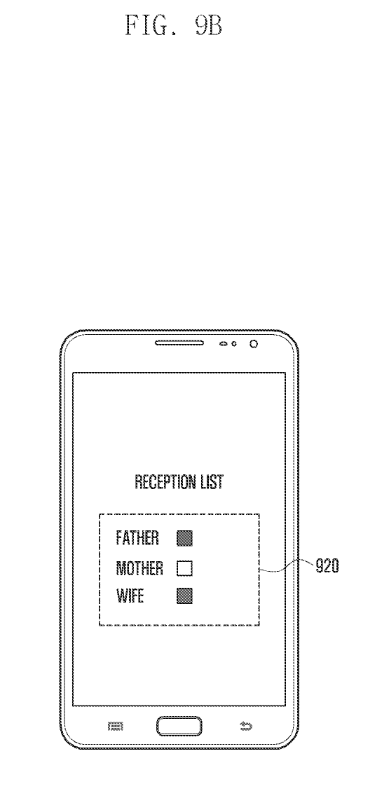

In operation 804, the processor 120 displays a reception setting mode on the display module 150. An example of the reception setting mode may be illustrated in FIG. 9A. FIG. 9A is a view illustrating an example of a form displayed when an electronic device receiving an incoming call sets the reception of alerting media according to an embodiment of the present disclosure. Referring to FIG. 9A, a message display window 910 which displays alerting media, namely, a message inquiring about the setting of reception of multimedia, may be included in the display module 150. Also, the processor 120 may display, on the display module 150, a first icon 912 which inquires about whether to set the reception of data of alerting media pre-stored in the electronic device or whether to set the reception of data of alerting media from all the electronic devices regardless of whether data of alerting media is stored; and a second icon 914 which inquires about whether data of alerting media is to be received from only a particular target.

In operation 806, the processor 120 determines whether a signal received from the user input module 140 requests the reception of alerting media from all the electronic devices. Specifically, this case may be a case in which the above-described first icon 912 is input.

When a result of the determination in operation 806 shows that alerting media are set to be received during call termination from all the electronic devices, the processor 120 proceeds to operation 810, and sets the reception of all lists and stores all of the received lists in the memory 130.

In contrast, a case, in which the result of the determination in operation 806 shows that the alerting media are not set to be received during the call termination from all the electronic devices, may be a case in which the second icon is input. Accordingly, when proceeding to operation 808, the processor 120 may display a telephone number list, which is pre-stored in the memory 130, on the display module 150, and may set the reception of alerting media and may store the received alerting media, in response to a user input. This configuration will be described with reference to FIG. 9B.

FIG. 9B is a view illustrating an example of a case in which a reception-side electronic device allows a termination call of alerting media from a particular user according to an embodiment of the present disclosure.

Referring to FIG. 9B, a pre-stored other party contact display window 920 may be displayed on the display module 150. The pre-stored other party contact display window 920 may be set so as to allow a termination call of alerting media for only a particular user in response to a user input.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for transmitting multimedia data during call origination in a communication terminal, the method comprising:
determining whether origination of a call is requested together with alerting media, when the origination of the call is requested; and
transmitting a call origination message and data of the alerting media when the origination of the call is requested together with the alerting media.

2. The method of claim 1, wherein the alerting media comprise at least one of text, a photograph, an emoticon, a sound, and a moving image.

3. The method of claim 1, further comprising storing the alerting media after production of the alerting media is completed.

4. The method of claim 1, further comprising displaying produced alerting media after production of the alerting media is completed.

5. The method of claim 1, further comprising selecting an alerting medium to be transmitted during the origination of the call, if the origination of the call is requested when the number of produced alerting media is two or more.

6. The method of claim 1, further comprising:
setting a target for which termination of the call including the alerting media is to be allowed during the termination of the call; and
displaying the alerting media in response to only the target, for which the termination of the call including the alerting media is allowed, when the call including the alerting media is terminated.

7. The method of claim 1, further comprising producing the alerting media.

8. The method of claim 7, wherein the alerting media is produced by using data which is input from a user input module and a camera module, upon receiving a request for the production of the alerting media.

9. A non-transitory computer readable recording medium having a program recorded thereon to implement the method of claim 1.

10. An apparatus for transmitting multimedia data during call origination in a communication terminal, the apparatus comprising:
a communication module configured to communicate with a counterpart terminal;
a display module configured to display produced alerting media and to display an operation of terminating a call, an operation of originating a call, a state of terminating the call, and a state of originating the call;
a memory configured to store data of the alerting media and an address of the counterpart terminal;
a user input module configured to generate an input signal matched to an input from a user;
a camera module configured to receive at least one of a still image, a moving image, and a sound signal; and
a controller configured to control the communication module to transmit the alerting media and a call origination message when the origination of the call is requested together with the alerting media.

11. The apparatus of claim 10, wherein the alerting media comprise at least one of text, a photograph, an emoticon, a sound, and a moving image.

12. The apparatus of claim 10, wherein the controller is configured to control the memory to store the produced alerting media after production of the alerting media is completed.

13. The apparatus of claim 10, wherein the controller is configured to control the display unit to display the produced alerting media after production of the alerting media is completed.

14. The apparatus of claim 10, wherein the controller is configured to control the display module to display the alerting media when the number of the produced alerting media is two or more, and to control the communication module to transmit the call origination message and at least one selected alerting medium, when the at least one of the displayed alerting media is selected via the user input module.

15. The apparatus of claim 10, wherein the controller is configured to control the display module to display a user address list stored in the memory when it is requested to set a target for which the termination of the call including the alerting media is to be allowed during the termination of the call, to set whether the termination of the call including the alerting media is allowed based on a signal which is input from the user input module, to control the memory to store the target for which the termination of the call including the alerting media is allowed, and to perform a control operation for displaying the alerting media in response to only the target for which the termination of the call including the alerting media is allowed, which is stored in the memory, when the call including the alerting media is terminated.

16. The apparatus of claim 10, wherein the controller is configured to perform a control operation for producing the alerting media by using data which is input from the user input module and the camera module, when the user input module receives a request for the production of the alerting media.
